(19) United States
(12) Patent Application Publication
(10) Pub. No.: US 2024/0047792 A1
(43) Pub. Date: Feb. 8, 2024

(54) SOLID-STATE BATTERY PACKAGE

(71) Applicant: Murata Manufacturing Co., Ltd., Nagaokakyo-shi (JP)

(72) Inventors: Kouji ISHIKAWA, Nagaokakyo-shi (JP); Haruhiko IKEDA, Nagaokakyo-shi (JP); Toshitaka HAYASHI, Nagaokakyo-shi (JP); Toshiya KAWATE, Nagaokakyo-shi (JP); Yoshiyuki TONAMI, Nagaokakyo-shi (JP)

(21) Appl. No.: 18/487,269

(22) Filed: Oct. 16, 2023

Related U.S. Application Data
(63) Continuation of application No. PCT/JP2022/018944, filed on Apr. 26, 2022.

(30) Foreign Application Priority Data
Apr. 26, 2021 (JP) 2021-074350

(51) Int. Cl. H01M 50/126; H01M 50/11; H01M 50/121

(52) U.S. Cl. CPC H01M 50/126; H01M 50/11; H01M 50/121

(57) ABSTRACT

A solid-state battery package that includes: a substrate; and a solid-state battery on the substrate. The solid-state battery has: a battery element having a positive electrode layer, a negative electrode layer, and a solid electrolyte; and an end-face electrode on an end face of the battery element and connected to one of the positive or negative electrode layers. The substrate has a substrate electrode layer on a main surface thereof, and at least a first side surface of the substrate electrode layer and a first end face of the end-face electrode are substantially on an identical line in a sectional view, a distance between the first side surface and a second side surface of the substrate electrode layer is equal to or more than a minimum distance between the first end face and an end surface of the positive or negative electrode layer that the end-face electrode is not connected.

### CROSS REFERENCE TO RELATED APPLICATIONS

The present application is a continuation of International application No. PCT/JP2022/018944, filed Apr. 26, 2022, which claims priority to Japanese Patent Application No. 2021-074350, filed Apr. 26, 2021, the entire contents of each of which are incorporated herein by reference.

### TECHNICAL FIELD

The present invention relates to a solid-state battery package. More specifically, the present invention relates to a solid-state battery packaged so as to be adapted for mounting on a board.

### BACKGROUND ART

Hitherto, secondary batteries that can be repeatedly charged and discharged have been used for various purposes. For example, secondary batteries are used as power sources of electronic devices such as smartphones and notebooks.

In secondary batteries, a liquid electrolyte is generally used as a medium for ion transfer contributing to charging and discharging. That is, a so-called electrolytic solution is used for the secondary battery. However, in such a secondary battery, safety is generally required from the viewpoint of preventing leakage of an electrolytic solution. Since an organic solvent or the like used for the electrolytic solution is a flammable substance, safety is required also in that respect.

Therefore, solid-state batteries using a solid electrolyte instead of an electrolytic solution have been studied.
Patent Document 1: Japanese Patent Application Laid-Open No. 2015-220107
Patent Document 2: Japanese Patent Application Laid-Open No. 2007-5279

### SUMMARY OF THE INVENTION

It is conceivable that a solid-state battery is used by being mounted on a printed wiring board and the like together with other electronic components, and in that case, a structure suitable for mounting is required. For example, a package in which a solid-state battery is disposed on a substrate has the substrate electrically connect with the outside and thereby is adapted for mounting.

The solid-state battery has: a battery element having a positive electrode layer, a negative electrode layer, and a solid electrolyte interposed between electrode layers of the positive electrode layer and the negative electrode layer; and an end-face electrode provided on the battery element. In addition, in the solid-state battery, the electrode layers (positive electrode layer/negative electrode layer) may expand and contract during charging and discharging. The inventors of the present application have noticed that there is still a problem to be overcome in previously proposed solid-state batteries, and have found a need to take measures therefor.

Specifically, the battery element expands and contracts due to expansion and contraction of the electrode layer. On the other hand, the end-face electrode itself provided on the battery element is less likely to expand and contract. Due to the difference in the degree of expansion and contraction, stress may act from the solid-state battery side to the substrate side. In particular, this stress may increase from the central region side of the battery element toward the interface region side between the electrode layer and the end-face electrode. That is, among the stresses acting from the solid-state battery side to the substrate side, the stress along the interface region between the electrode layer and the end-face electrode becomes relatively the largest. Therefore, the largest stress acts on a predetermined portion of the main surface of the substrate located below the end-face electrode, and thereby the substrate may be cleaved. As a result, the cleaved substrate may cause infiltration of moisture from the external environment, and may cause deterioration of battery characteristics.

The present invention has been devised in view of such problems. That is, a main object of the present invention is to provide a solid-state battery package capable of suitably suppressing substrate cleavage.

To achieve the above object, an aspect of the present invention provides: a solid-state battery package including a substrate and a solid-state battery on the substrate. The solid-state battery has: a battery element having a positive electrode layer, a negative electrode layer, and a solid electrolyte interposed between the positive electrode layer and the negative electrode layer; and an end-face electrode on an end face of the battery element and connected to one of the positive electrode layer or the negative electrode layer. The substrate has, on a main surface thereof on a side opposite to the solid-state battery, a substrate electrode layer, and at least a first side surface of the substrate electrode layer and a first end face of the end-face electrode are substantially on an identical line in a sectional view of the solid-state battery package, a distance between the first side surface and a second side surface of the substrate electrode layer opposite to the first side surface is equal to or more than a minimum distance between the first end face of the end-face electrode and an end surface of the one of the positive electrode layer or the negative electrode layer that the end-face electrode is not connected.

The solid-state battery package according to one aspect of the present invention is capable of suitably suppressing substrate cleavage.

### BRIEF EXPLANATION OF THE DRAWINGS

FIG. 1 is a sectional view schematically illustrating the internal configuration of a solid-state battery.

FIG. 2 is a sectional view schematically illustrating the configuration of a packaged solid-state battery according to one aspect of the present invention.

FIG. 3 is a sectional view schematically illustrating the configuration of a packaged solid-state battery according to another aspect of the present invention.

FIG. 4 is a sectional view schematically illustrating the configuration of a packaged solid-state battery according to another aspect of the present invention.

FIG. 5 is a sectional view schematically illustrating the configuration of a packaged solid-state battery according to another aspect of the present invention.

FIG. 6 is a sectional view schematically illustrating the configuration of a packaged solid-state battery according to another aspect of the present invention.

FIG. 7 is a sectional view schematically illustrating the configuration of a packaged solid-state battery according to another aspect of the present invention.

FIG. 8 is a sectional view schematically illustrating the configuration of a packaged solid-state battery according to another aspect of the present invention.

FIG. 9 is a sectional view schematically illustrating the configuration of a packaged solid-state battery according to another aspect of the present invention.

FIG. 10 is a sectional view schematically illustrating the configuration of a packaged solid-state battery according to another aspect of the present invention.

FIG. 11 is a sectional view schematically illustrating the configuration of a packaged solid-state battery according to another aspect of the present invention.

FIG. 12 is a sectional view schematically illustrating a solid-state battery package, and is a schematic view particularly illustrating a certain substrate configuration example.

FIG. 13A is a step sectional view schematically illustrating a process for manufacturing a solid-state battery package according to an aspect of the present invention.

FIG. 13B is a step sectional view schematically illustrating a process for manufacturing a solid-state battery package according to an aspect of the present invention.

FIG. 13C is a step sectional view schematically illustrating a process for manufacturing a solid-state battery package according to an aspect of the present invention.

FIG. 13D is a step sectional view schematically illustrating a process for manufacturing a solid-state battery package according to an aspect of the present invention.

FIG. 13E is a step sectional view schematically illustrating a process for manufacturing a solid-state battery package according to an aspect of the present invention.

### DETAILED DESCRIPTION OF THE INVENTION

Hereinafter, a solid-state battery package according to the present invention will be described in detail. Although the description will be made with reference to the drawings as necessary, the illustrated contents are only schematically and exemplarily illustrated for the understanding of the present invention, and the appearance, the dimensional ratio, or the like may be different from the actual ones.

The term “solid-state battery package” as used herein refers, in a broad sense, to a solid-state battery device (or a solid-state battery article) configured to protect the solid-state battery from the external environment, and in a narrow sense, to a solid-state battery article that includes a substrate adapted for mounting and protects the solid-state battery from the external environment.

The term “sectional view” as used herein is based on a form viewed from a direction substantially perpendicular to the stacking direction in the stacked structure of the solid-state battery (briefly, a form in the case of being cut along a plane parallel to the layer thickness direction). In addition, the term “plan view” or “plan view shape” used in the present specification is based on a sketch drawing when an object is viewed from an upper side or a lower side along the layer thickness direction (that is, the above stacking direction).

The terms “up-down direction” and “left-right direction” directly or indirectly used in the present specification respectively correspond to the up-down direction and the left-right direction in the drawings. Unless otherwise specified, the same reference signs or symbols denote the same members and sites, or the same semantic contents. In one preferred aspect, it can be considered that a vertical downward direction (that is, a direction in which gravity acts) corresponds to a “downward direction”/“bottom side” and the opposite direction corresponds to an “upward direction”/“top side”.

The term “solid-state battery” used in the present invention refers to, in a broad sense, a battery whose constituent elements are composed of solid and refers to, in a narrow sense, all solid-state battery whose constituent elements (particularly preferably all constituent elements) are composed of solid. In a preferred aspect, the solid-state battery in the present invention is a stacked solid-state battery configured such that layers constituting a battery constituent unit are stacked on each other, and such layers are preferably composed of fired bodies. The term “solid-state battery” encompasses not only a so-called “secondary battery” that can be repeatedly charged and discharged but also a “primary battery” that can only be discharged. According to a preferred aspect of the present invention, the “solid-state battery” is a secondary battery. The term “secondary battery” is not to be considered excessively restricted by its name, which can encompass, for example, a power storage device and the like. In the present invention, the solid-state battery included in the package can also be referred to as a “solid-state battery element”.

Hereinafter, the basic configuration of the solid-state battery according to the present invention will be first described. The configuration of the solid-state battery described here is merely an example for understanding the invention, and not considered limiting the invention.

[Basic Configuration of Solid-State Battery]

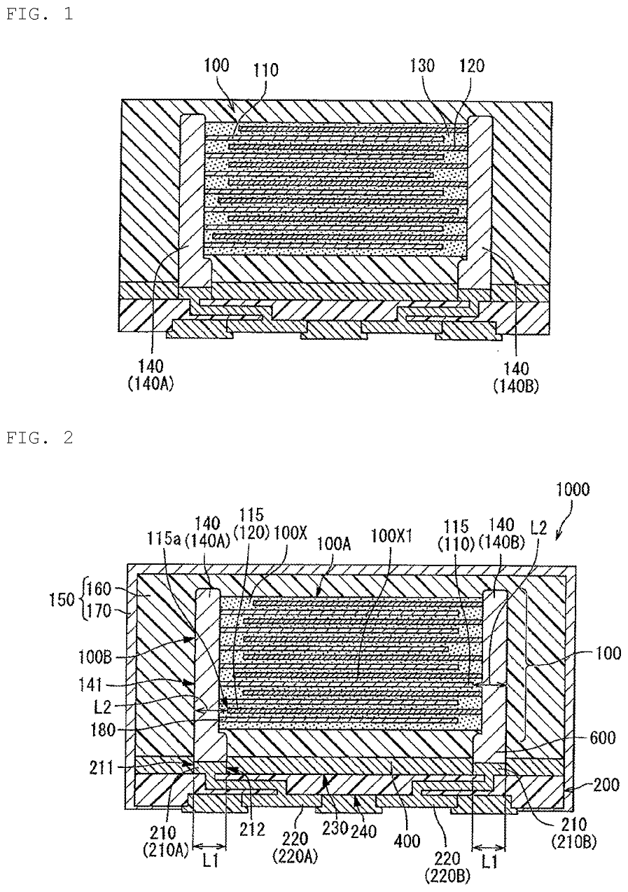

The solid-state battery includes: at least electrode layers: a positive electrode and a negative electrode; and a solid electrolyte. Specifically, as illustrated in FIG. 1, a solid-state battery 100 includes a solid-state battery stacked body including a battery constituting unit composed of a positive electrode layer 110, a negative electrode layer 120, and a solid electrolyte 130 at least interposed between the electrode layers.

For the solid-state battery, each layer constituting the solid-state battery may be formed by firing, and the positive electrode layer, the negative electrode layer, the solid electrolyte, and the like may form fired layers. Preferably, the positive electrode layer, the negative electrode layer, and the solid electrolyte are each fired integrally with each other, and thus, the solid-state battery stacked body preferably forms an integrally fired body.

The positive electrode layer 110 is an electrode layer containing at least a positive electrode active material. The positive electrode layer may further contain a solid electrolyte. In a preferred aspect, the positive electrode layer is composed of a fired body including at least positive electrode active material particles and solid electrolyte particles. In contrast, the negative electrode layer is an electrode layer containing at least a negative electrode active material. The negative electrode layer may further contain a solid electrolyte. In a preferred aspect, the negative electrode layer is composed of a sintered body containing at least negative electrode active material particles and solid electrolyte particles.

The positive electrode active material and the negative electrode active material are substances involved in the transfer of electrons in the solid-state battery. Ions move (or conduct) between the positive electrode layer and the negative electrode layer through the solid electrolyte to accept and donate electrons, whereby charging and discharging are performed. Each electrode layer of the positive electrode layer and the negative electrode layer is preferably a layer capable of occluding and releasing lithium ions or sodium ions, in particular. More particularly, the solid-state battery is preferably an all-solid-state secondary battery in which lithium ions or sodium ions move between the positive electrode layer and the negative electrode layer through the solid electrolyte interposed, thereby charging and discharging the battery.

(Positive Electrode Active Material)

Examples of the positive electrode active material included in the positive electrode layer 110 include at least one selected from the group consisting of lithium-containing phosphate compounds that have a NASICON-type structure, lithium-containing phosphate compounds that have an olivine-type structure, lithium-containing layered oxides, lithium-containing oxides that have a spinel-type structure, and the like. Examples of the lithium-containing phosphate compounds that have a NASICON-type structure include Li₃V₂(PO₄)₃. Examples of the lithium-containing phosphate compounds that have an olivine-type structure include Li₃Fe₂(PO₄)₃, LiFePO₄, and/or LiMnPO₄. Examples of the lithium-containing layered oxides include LiCoO₂ and/or LiCo_{1/3}Ni_{1/3}Mn_{1/3}O₂. Examples of the lithium-containing oxides that have a spinel-type structure include LiMn₂O₄ and/or LiNi_{0.5}Mn_{1.5}O₄. The types of the lithium compounds are not particularly limited, and may be regarded as, for example, a lithium-transition metal composite oxide and a lithium-transition metal phosphate compound. The lithium-transition metal composite oxide is a generic term for oxides containing lithium and one or two or more transition metal elements as constituent elements, and the lithium transition metal phosphate compound is a generic term for phosphate compounds containing lithium and one or two or more transition metal elements as constituent elements. The types of transition metal elements are not particularly limited and are, for example, cobalt (Co), nickel (Ni), manganese (Mn), iron (Fe), and the like.

In addition, examples of positive electrode active materials capable of occluding and releasing sodium ions include at least one selected from the group consisting of sodium-containing phosphate compounds that have a NASICON-type structure, sodium-containing phosphate compounds that have an olivine-type structure, sodium-containing layered oxides, sodium-containing oxides that have a spinel-type structure, and the like. For example, in the case of the sodium-containing phosphate compounds, examples thereof include at least one selected from the group consisting of Na₃V₂(PO₄)₃, NaCoFe₂ (PO₄)₃, Na₂Ni₂Fe (PO₄)₃, Na₃Fe₂ (PO₄)₃, Na₂FeP₂O₇, Na₄Fe₃(PO₄)₂(P₂O₇), and NaFeO₂ as a sodium-containing layered oxide.

In addition, the positive electrode active material may be, for example, an oxide, a disulfide, a chalcogenide, a conductive polymer, or the like. The oxide may be, for example, a titanium oxide, a vanadium oxide, a manganese dioxide, or the like. The disulfide is, for example, a titanium disulfide, a molybdenum sulfide, or the like. The chalcogenide may be, for example, a niobium selenide or the like. The conductive polymer may be, for example, a disulfide, a polypyrrole, a polyaniline, a polythiophene, a poly-para-styrene, a polyacetylene, a polyacene, or the like.

(Negative Electrode Active Material)

Examples of the negative electrode active material included in the negative electrode layer 120 include at least one selected from the group consisting of oxides containing at least one element selected from the group consisting of titanium (Ti), silicon (Si), tin (Sn), chromium (Cr), iron (Fe), niobium (Nb), and molybdenum (Mo), carbon materials such as graphite, graphite-lithium compounds, lithium alloys, lithium-containing phosphate compounds that have a NASICON-type structure, lithium-containing phosphate compounds that have an olivine-type structure, and lithium-containing oxides that have a spinel-type structure. Examples of the lithium alloys include Li—Al. Examples of the lithium-containing phosphate compounds that have a NASICON-type structure include Li₃V₂(PO₄)₃ and/or LiTi₂(PO₄)₃. Examples of the lithium-containing phosphate compounds that have an olivine-type structure include Li₃Fe₂(PO₄)₃ and/or LiCuPO₄. Examples of the lithium-containing oxides that have a spinel-type structure include Li₄Ti₅O₁₂.

In addition, examples of negative electrode active materials capable of occluding and releasing sodium ions include at least one selected from the group consisting of sodium-containing phosphate compounds that have a NASICON-type structure, sodium-containing phosphate compounds that have an olivine-type structure, and sodium-containing oxides that have a spinel-type structure.

Further, in the solid-state battery, the positive electrode layer and the negative electrode layer are made of the same material.

The positive electrode layer and/or the negative electrode layer may include a conductive material. Examples of the conductive material included in the positive electrode layer and the negative electrode layer include at least one of metal materials such as silver, palladium, gold, platinum, aluminum, copper, and nickel, and carbon.

Further, the positive electrode layer and/or the negative electrode layer may include a sintering aid. Examples of the sintering aid include at least one selected from the group consisting of a lithium oxide, a sodium oxide, a potassium oxide, a boron oxide, a silicon oxide, a bismuth oxide, and a phosphorus oxide.

The thicknesses of the positive electrode layer and negative electrode layer are not particularly limited, but may be, independently of each other, for example, 2 μm to 50 μm, particularly 5 μm to 30 μm.

(Positive Electrode Current Collecting Layer/Negative Electrode Current Collecting Layer)

Although not an essential element for the electrode layer, the positive electrode layer 110 and the negative electrode layer 120 may respectively include a positive electrode current collecting layer and a negative electrode current collecting layer. The positive electrode current collecting layer and the negative electrode current collecting layer may each have the form of a foil. The positive electrode current collecting layer and the negative electrode current collecting layer may each have, however, the form of a fired body, if more importance is placed on viewpoints such as improving the electron conductivity, reducing the manufacturing cost of the solid-state battery, and/or reducing the internal resistance of the solid-state battery by integral firing. As the positive electrode current collector constituting the positive electrode current collecting layer and the negative electrode current collector constituting the negative electrode current collecting layer, it is preferable to use a material with a high conductivity, and for example, silver, palladium, gold, platinum, aluminum, copper, and/or nickel may be used. The positive electrode current collector and the negative electrode current collector may each have an electrical connection for being electrically connected to the outside, and may be configured to be electrically connectable to an end-face electrode. It is to be noted that when the positive electrode current collecting layer and the negative electrode current collecting layer have the form of a fired body, the layers may be composed of a fired body including a conductive material and a sintering aid. The conductive material included in the positive electrode current collecting layer and the negative electrode current collecting layer may be selected from, for example, the same materials as the conductive materials that can be included in the positive electrode layer and the negative electrode layer. The sintering aid included in the positive electrode current collecting layer and the negative electrode current collecting layer may be selected from, for example, the same materials as the sintering aids that can be included in the positive electrode layer/the negative electrode layer. As described above, in the solid-state battery, the positive electrode current collecting layer and the negative electrode current collecting layer are not essential, and a solid-state battery provided without such a positive electrode current collecting layer or a negative electrode current collecting layer is also conceivable. More particularly, the solid-state battery included in the package included the present invention may be a solid-state battery without any current collecting layer.

(Solid Electrolyte)

The solid electrolyte is a material capable of conducting lithium ions or sodium ions. In particular, the solid electrolyte 130 that forms the battery constituent unit in the solid-state battery may form a layer capable of conducting lithium ions between the positive electrode layer 110 and the negative electrode layer 120. It is to be noted that the solid electrolyte has only to be provided at least between the positive electrode layer and the negative electrode layer. More particularly, the solid electrolyte may be present around the positive electrode layer and/or the negative electrode layer so as to protrude from between the positive electrode layer and the negative electrode layer. Specific examples of the solid electrolyte include any one, or two or more of a crystalline solid electrolyte, a glass-based solid electrolyte, and a glass ceramic-based solid electrolyte.

Examples of the crystalline solid electrolyte include oxide-based crystal materials and sulfide-based crystal materials. Examples of the oxide-based crystal materials include lithium-containing phosphate compounds that have a NASICON structure, oxides that have a perovskite structure, oxides that have a garnet-type or garnet-type similar structure, and oxide glass ceramic-based lithium ion conductors. Examples of the lithium-containing phosphate compound that has a NASICON structure include LiₓM_{y}(PO₄)₃ (1≤x≤2, 1≤y≤2, M is at least one selected from the group consisting of titanium (Ti), germanium (Ge), aluminum (Al), gallium (Ga), and zirconium (Zr)). Examples of the lithium-containing phosphate compounds that have a NASICON structure include Li_{1.2}Al_{0.2}Ti_{1.8}(PO₄)₃. Examples of the oxides that have a perovskite structure include La_{0.55}Li_{0.35}TiO₃. Examples of the oxides that have a garnet-type or garnet-type similar structure include Li₇La₃Zr₂O₁₂. In addition, examples of the sulfide-based crystal materials include thio-LISICON, for example, Li_{3.25}Ge_{0.25}P_{0.75}S₄ and Li₁₀GeP₂Si₂. The crystalline solid electrolyte may contain a polymer material (for example, a polyethylene oxide (PEO)).

Examples of the glass-based solid electrolyte include oxide-based glass materials and sulfide-based glass materials. Examples of the oxide-based glass materials include 50Li₄SiO₄-50Li₃BO₃. In addition, examples of the sulfide-based glass materials include 30Li₂S-26B₂S₃-44LiI, 63Li₂S-36SiS₂-1Li₃PO₄, 57Li₂S-38SiS₂-5Li₄SiO₄, 70Li₂S-30P₂S₅, and 50Li₂S-5OGeS₂.

Examples of the glass ceramic-based solid electrolyte include oxide-based glass ceramic materials and sulfide-based glass ceramic materials. As the oxide-based glass ceramic materials, for example, a phosphate compound (LATP) containing lithium, aluminum, and titanium as constituent elements, and a phosphate compound (LAGP) containing lithium, aluminum, and germanium as constituent elements can be used. LATP is, for example, Li_{1.07}Al_{0.69}Ti_{1.46} (PO₄) 3. LAGP is, for example, Li_{1.5}Al_{0.5}Ge_{1.5} (PO₄). In addition, examples of the sulfide-based glass ceramic materials include Li₇P₃S₁₁ and Li_{3.25}P_{0.95}S₄.

In addition, examples of the solid electrolyte capable of conducting sodium ions include sodium-containing phosphate compounds that have a NASICON structure, oxides that have a perovskite structure, and oxides that have a garnet-type or garnet-type similar structure. Examples of the sodium-containing phosphate compound having a nasicon structure include NaₓM_{y}(PO₄)₃ (1≤x≤2, 1≤y≤2, M is at least one selected from the group consisting of Ti, Ge, Al, Ga and Zr).

The solid electrolyte may include a sintering aid. The sintering aid included in the solid electrolyte may be selected from, for example, the same materials as the sintering aids, which can be included in the positive electrode layer/the negative electrode layer.

The thickness of the solid electrolyte is not particularly limited. The thickness of the solid electrolyte layer located between the positive electrode layer and the negative electrode layer may be, for example, 1 μm to 15 μm, particularly 1 μm to 5 μm.

(End-face Electrode)

The solid-state battery is typically provided with end-face electrodes 140. In particular, an end-face electrode is provided on a side surface of the solid-state battery. More specifically, the side surfaces are provided with a positive-electrode-side end-face electrode 140A connected to the positive electrode layer 110 and a negative-electrode-side end-face electrode 140B connected to the negative electrode layer 120 (see FIG. 1). Such end-face electrodes preferably contain a material having high conductivity. The specific materials of the end-face electrodes are to be considered not particularly limited, but examples thereof include at least one selected from the group consisting of silver, gold, platinum, aluminum, copper, tin, and nickel.

[Feature of Solid-State Battery Package According to Present Invention]

According to the present invention, the solid-state battery is packaged. More particularly, the solid-state battery package includes a substrate adapted for mounting, and has a configuration in which the solid-state battery is protected from the external environment.

FIG. 2 is a sectional view schematically illustrating the configuration of a packaged solid-state battery according to one aspect of the present invention. As illustrated in FIG. 2, a solid-state battery package 1000 according to an aspect of the present invention includes a substrate 200 so that a solid-state battery 100 is supported. Specifically, the solid-state battery package 1000 includes the substrate 200 adapted for mounting and the solid-state battery 100 provided on the substrate 200 and protected from the external environment.

The inventors of the present application have intensively studied a solution for suitably suppressing cleavage of the substrate 200 in the solid-state battery package 1000, and as a result, have devised the present invention having the following technical idea.

Specifically, the present invention has a technical idea that at the portion to be readily acted by the stress from the solid-state battery 100 side to the substrate 200 side that may occur at the time of charging and discharging the solid-state battery 100, which has been found by the inventors of the present application, a member that makes the stress less likely to act on the substrate 200 is purposely provided.

To achieve the technical idea mentioned above, the present invention has the following technical feature (see FIG. 2). Specifically, the substrate 200 has a configuration that the substrate 200 has, on one main surface 230 on a side opposite to the solid-state battery 100, at least one of: a positive-electrode-side substrate electrode layer 210A; and a negative-electrode-side substrate electrode layer 210B disposed to be separately opposed to the positive-electrode-side substrate electrode layer 210A, each of which is capable of electrical connection with the solid-state battery 100.

On the other hand, the substrate 200 includes, on another main surface 240, a substrate electrode layer 220 with which the solid-state battery package 1000 is mounted to an external board, specifically, a positive-electrode-side substrate electrode layer 220A and a negative-electrode-side substrate electrode layer 220B disposed to be separately opposed to the positive-electrode-side substrate electrode layer 220A. The substrate electrode layer 210 on the solid-state battery installation side and the substrate electrode layer 220 on the mounting side are configured to be electrically connectable via a metal member provided inside the substrate 200. The metal member may be made of, for example, at least one metal material selected from the group consisting of copper, aluminum, stainless steel, nickel, silver, gold, tin, and the like.

For enabling electrical connection between the solid-state battery 100 and the substrate electrode layers 210 of the substrate 200, the end-face electrodes 140 of the solid-state battery 100 and the substrate electrode layer 210 of the substrate 200 can be connected with a bonding member 600 interposed therebetween. The bonding member 600 plays a part in at least electrical connection between the end-face electrodes 140 of the solid-state battery 100 and the substrate 200, and may include, for example, a conductive adhesive. As an example, the bonding member 600 may be made of an epoxy-based conductive adhesive containing a metal filler such as Ag.

When the positive-electrode-side substrate electrode layer 210A and the negative-electrode-side substrate electrode layer 210B are not particularly distinguished, reference sign 210 is used for the substrate electrode layers. When the positive electrode layer 110 and the negative electrode layer 120 are not particularly distinguished from each other, reference sign 115 is used as the reference sign of the electrode layers. When the positive-electrode-side end-face electrode 140A and the end-face electrode 140B of the negative electrode layer are not particularly distinguished, reference sign 140 is used as the reference sign of the end-face electrodes.

On the premise of the above configuration, as illustrated in FIG. 2, with respect to a case where at least one side surface 211 of the substrate electrode layer 210 and an end face 141 of the end-face electrode 140 are substantially on an identical line, a distance Li between the one side surface 211 and another side surface 212 of the substrate electrode layer 210 is equal to or more than a minimum distance L2 between the end face 141 of the end-face electrode 140 on the same electrode side and a side surface 115a of the solid-state battery electrode layer 115 on an opposite electrode side that is separately opposed to the end face 141. The term “solid-state battery electrode layer” as used herein refers to an electrode layer that is a component of the solid-state battery, and may also be referred to as an electrode layer on the solid-state battery side. The term “substrate electrode layer” as used herein refers to an electrode layer that is a component of the substrate, and may also be referred to as an electrode layer on the substrate side. Specifically, the term “substrate electrode layer” particularly refers to an electrode layer disposed on the main surface on a side opposite to the solid-state battery (which may also be referred to as an upper main surface), which is on the reverse side of the main surface on which an external board is mounted, of the two main surfaces of the substrate opposite to each other. The phrase “one side surface of the substrate electrode layer and an end face of the end-face electrode are substantially on an identical line” refers to a positional relationship in which the end face of the end-face electrode and the one side surface of the substrate electrode layer are substantially in series with each other via a bonding member or directly. The one side surface of the substrate electrode layer referred to herein includes not only an actual one side surface of the substrate electrode layer but also an apparent one side surface that can be arranged in series with the end face of the end-face electrode. Each of the end face of the end-face electrode and the one side surface of the substrate electrode layer may be linear or curved.

As found by the inventor of the present application, among the stresses acting from the solid-state battery 100 side to the substrate 200 side, the stress along the interface region 180 between the solid-state battery electrode layer 115 and the end-face electrode 140 is relatively the largest, so that the stress can act on the predetermined portion side of the substrate 200 located below the end-face electrode 140. In a broad sense, the term “interface region” used in the present specification refers to a region including a boundary portion where the solid-state battery electrode layer 115 and the end-face electrode 140 are in contact with each other and a vicinity portion of the boundary portion. The term “interface region” as used herein refers in a narrow sense to a portion of 0% or more and less than 5% of the width of the region between the interface region and the central region of the battery element with respect to the interface region.

In this regard, according to the above technical feature, in a sectional view, a distance Li between the one side surface 211 and the another side surface 212 of the substrate electrode layer 210 (corresponding to the width dimension of the substrate electrode layer 210) is equal to or more than a minimum distance L2 between the end face 141 of the end-face electrode 140 on the same electrode side and the side surface 115a of the solid-state battery electrode layer 115 on the opposite electrode side. In other words, in a sectional view, the another side surface 212 of the substrate electrode layer 210 and the side surface 115a of the solid-state battery electrode layer 115 on the opposite electrode side can be located on substantially an identical line. The term “minimum distance” as used herein refers to a distance at which a straight line horizontal distance connecting a predetermined portion of the end face of the end-face electrode and a predetermined portion of the side surface of the solid-state battery electrode layer on an opposite electrode side, which is separately opposed thereto, is minimized.

As a result, in a sectional view, the another side surface 212 of the substrate electrode layer 210 is positioned more inward from an interface region 180 of the solid-state battery electrode layer 115 on the same electrode side and the end-face electrode 140. Therefore, the largest stress that can act on the substrate 200 side along the interface region 180 between the solid-state battery electrode layer 115 on the same electrode side and the end-face electrode 140 is received by the substrate electrode layer 210 not with a “Point” but with a “Surface”. That is, the substrate electrode layer 210 can function as a “stress-receiving layer”, specifically, a ““planar” stress-receiving layer”.

Further, the substrate electrode layer 210 itself can be electrically connected to the solid-state battery 100, and therefore can be formed of a metal layer having relatively high strength. The metal layer may be made of, for example, copper (Cu) plated with gold (Au) (Cu—Au) or copper (Cu) plated with nickel (Ni) and gold (Au) (Cu—Ni—Au). Although not particularly limited, the thickness of the substrate electrode layer 210 can be 2 to 50 μm, for example, 30 μm.

From the above, the largest stress that can act on the substrate 200 side along the interface region 180 between the solid-state battery electrode layer 115 on the same electrode side and the end-face electrode 140 can be received by the “Surface” substrate electrode layer 210 having relatively high strength. Due to the stress reception by the substrate electrode layer 210, it is possible to suppress the stress from acting on a predetermined portion of the main surface 230 of the substrate 200 along the interface region 180 between the solid-state battery electrode layer 115 and the end-face electrode 140. As a result, according to an aspect of the present invention, it is possible to suitably suppress cleavage of the substrate 200. By suppressing the cleavage of the substrate, it is possible to suppress moisture infiltration from the external environment to the solid-state battery 100 through the substrate 200. Therefore, according to an aspect of the present invention, battery characteristics can be improved.

In the above description, according to the main characteristic part of the present invention, contents related to cleavage suppression of the substrate 200 by stress reception of the substrate electrode layer 210 have been described. In addition, the solid-state battery package 1000 according to an aspect of the present invention may also have a property of preventing water vapor transmission as follows. Therefore, the contents related to the water vapor transmission prevention will be described below. It is to be noted that the term “water vapor” as used in the present specification is not particularly limited to water in a gaseous state, and also encompasses water in a liquid state and the like. That is, the term “water vapor” is used to broadly include matters related to water regardless of the physical state. Accordingly, the term “water vapor” can also be referred to as moisture or the like, and in particular, the water in the liquid state can also encompass dew condensation water obtained by condensation of water in a gaseous state.

As described above, the substrate 200 supports the solid-state battery 100. Therefore, the substrate 200 is provided so as to block the main surface of the solid-state battery 100 from the external environment. The presence of the substrate 200 can also suppress the infiltration of water vapor into the solid-state battery 100.

As illustrated in FIG. 2, the substrate 200 has, for example, a main surface larger than the solid-state battery. Further, the substrate 200 may be a resin substrate. Alternatively, the substrate 200 may be a ceramic substrate. In short, the substrate 200 may fall in the category such as a printed wiring board, a flexible substrate, an LTCC substrate, and an HTCC substrate. When the substrate 200 is a resin substrate, the substrate 200 may be a substrate composed to include a resin as a base material, for example, a substrate that has a stacked structure including therein a resin layer. The resin material of such a resin layer may be any thermoplastic resin and/or any thermosetting resin. In addition, the resin layer may be formed by impregnating a glass fiber cloth with a resin material such as an epoxy resin, for example.

The substrate preferably serves as a member for an external terminal of the packaged solid-state battery. More particularly, the substrate can be also considered as a terminal substrate for an external terminal of the solid-state battery. The solid-state battery package including such a substrate allows the solid-state battery to be mounted on another external board (That is, a secondary substrate) such as a printed wiring board, with the substrate interposed therebetween. For example, the solid-state battery can be surface-mounted via a support substrate through solder reflow and the like. For the reasons described above, the solid-state battery package according to the present invention is preferably a surface-mount-device (SMD) type battery package.

Furthermore, according to an aspect of the present invention, not only the substrate 200 but also the solid-state battery package 1000 itself can be configured to prevent water vapor permeation as a whole. For example, the solid-state battery package 1000 according to an aspect of the present invention can be covered with a covering material 150 such that the whole of the solid-state battery 100 provided on the substrate 200 is surrounded. Specifically, it may be packaged so that a main surface 100A and a side surface 100B of the solid-state battery 100 on the substrate 200 is surrounded by the covering material 150. In such a configuration, all surfaces forming the solid-state battery 100 are not exposed to the outside, and water vapor transmission can be more suitably prevented.

For example, as shown in FIG. 2, the covering material 150 may be composed of a covering insulating layer and a covering inorganic layer, and may have a form in which at least the solid-state battery 100 is covered with a covering insulating layer 160 and a covering inorganic layer 170 as the covering material 150.

The covering insulating layer 160 is a layer provided so as to cover the main surface 100A and the side surface 100B of the solid-state battery 100. The covering insulating layer 160 largely wraps the solid-state battery 100 on the substrate 200 as a whole. The material of the covering insulating layer may be any type as long as it exhibits the insulating properties. For example, the covering insulating layer 160 may include a resin, and the resin may be either a thermosetting resin or a thermoplastic resin. The covering insulating layer 160 may include an inorganic filler. By way of example only, the covering insulating layer 160 may be made of an epoxy-based resin containing an inorganic filler such as SiC.

The covering inorganic layer 170 is provided so as to cover the covering insulating layer 160. As shown in FIG. 2, the covering inorganic layer 170 is positioned on the covering insulating layer 160, and thus has a form of largely enclosing the solid-state battery 100 on the substrate 200 as a whole together with the covering insulating layer 160. The covering inorganic layer may have, for example, a film form. Furthermore, the covering inorganic layer 170 may have the form of also covering a side surface 250 of the substrate 200. The covering insulating layer 160 forms a suitable water vapor barrier together with the covering inorganic layer 170, and the covering inorganic layer 170 forms a suitable water vapor barrier together with the covering insulating layer 160. The material of the covering inorganic layer 170 is not particularly limited, and may be metal, glass, oxide ceramics, a mixture thereof, or the like. The covering inorganic layer 170 may correspond to an inorganic layer that has the form of a thin film, which is preferably, for example, a metal film. Although it is merely one example, the covering inorganic layer 170 may be formed of a plated Cu-based and/or Ni-based material having a thickness of 2 μm to 50 μm.

Hereinafter, preferred aspects of the present invention will be described.

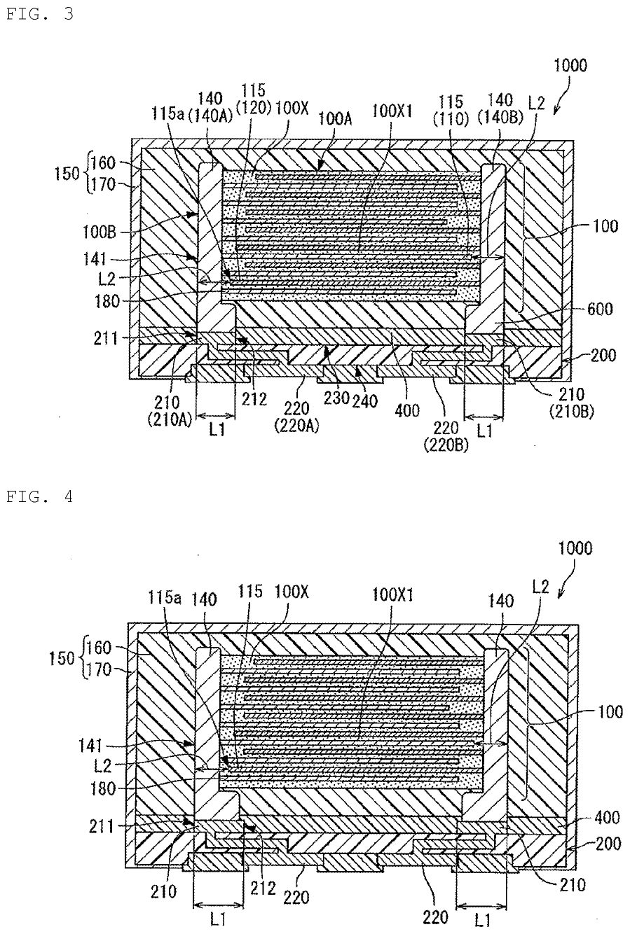

In a preferred aspect, in a sectional view, the another side surface 212 of the substrate electrode layer 210 is positioned more inward from the side surface 115a of the solid-state battery electrode layer 115 on the opposite electrode side (see FIG. 3).

FIG. 3 is a sectional view schematically illustrating the configuration of a packaged solid-state battery according to another aspect of the present invention. As described above, the basic aspect of the present invention shown in FIG. 2 is based on the case where the another side surface 212 of the substrate electrode layer 210 and the side surface 115a of the solid-state battery electrode layer 115 on the opposite electrode side can be located on substantially the identical line in a sectional view. On the other hand, the aspect shown in FIG. 3 is characterized in that the another side surface 212 of the substrate electrode layer 210 is positioned more inward from the side surface 115a of the solid-state battery electrode layer 115 on the opposite electrode side, as compared with the aspect illustrated in FIG. 2.

As found by the inventor of the present application, the stress acting from the solid-state battery 100 side to the substrate 200 side may increase toward the interface region 180 side between the electrode layer 115 and the end-face electrode 140. From this, the stress along the interface region 180 is the largest, and the stress can gradually decrease from the interface region 180 toward the central region of a battery element 100X. The term “battery element” as used herein refers to one including the positive electrode layer 110, the negative electrode layer 120, and the solid electrolyte 130, excluding the end-face electrode.

Based on this point, the another side surface 212 of the substrate electrode layer 210 is positioned more inward from the side surface 115a of the solid-state battery electrode layer 115 on the opposite electrode side. That is, the substrate electrode layer 210 is extended to a position that enables opposition to the solid-state battery electrode layer 115 on the opposite electrode side in a sectional view. As a result, as compared with the basic aspect shown in FIG. 2, it is possible to expand the region of the substrate electrode layer 210 that can function as a planar stress-receiving layer.

As a result, among the stresses that can act on the substrate 200 side, the stress along the region between the interface region 180 and the central region 100X1 of the battery element 100X can also be received by the “Surface” substrate electrode layer 210 having relatively high strength. As a result, it is also possible to suppress the stress along the region between the interface region 180 and the central region 100X1 of the battery element 100X from acting on a predetermined portion of the main surface 230 of the substrate 200.

As an example, the distance Li (corresponding to a width dimension) between the one side surface 211 and the another side surface 212 of the substrate electrode layer 210 is preferably 1.5 times or more of the minimum distance L2 in a sectional view (see FIG. 4).

FIG. 4 is a sectional view schematically illustrating the configuration of a packaged solid-state battery according to another aspect of the present invention. As described above, the stress that can act on the substrate 200 side has a property that the stress can gradually decrease from the interface region 180 toward the central region of the battery element 100X. Therefore, in the region between the interface region 180 and the central region 100X1 of the battery element 100X, the stress along the region close to the interface region 180 is also relatively slightly smaller than the stress along the interface region 180. Therefore, stress along this range also adversely affects the substrate 200 side. As used herein, the “region close to the interface region” refers to a portion larger than 5% of and equal to or smaller than 20% of the width of the region between the interface region 180 and the central region 100X1 of the battery element 100X with respect to the interface region 180.

Based on this point, the width dimension of the substrate electrode layer 210 is set to 1.5 times or more of the above-described minimum distance L2. As a result, as compared with the basic aspect of the present invention shown in FIG. 2, it is possible to expand the region of the substrate electrode layer 210 that can function as a planar stress-receiving layer. As a result, the stress along the region close to the interface region 180 can also be suitably received by the “Surface” substrate electrode layer 210 having a relatively high strength.

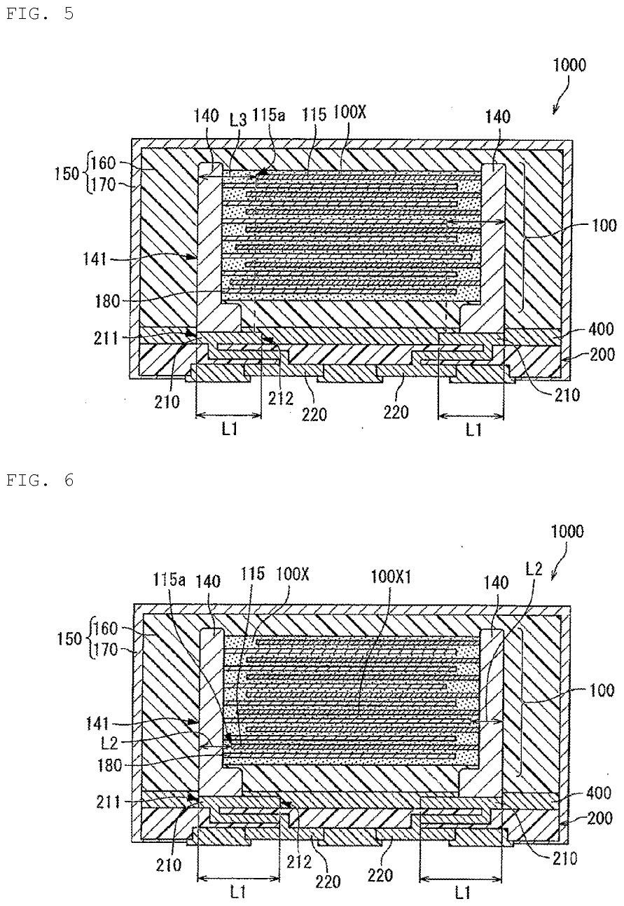

From the same point of view, the distance Li (corresponding to a width dimension) between the one side surface 211 and the another side surface 212 of the substrate electrode layer 210 is preferably equal to or more than a maximum distance L3 between the end face 141 of the end-face electrode 140 on the same electrode side and the side surface 115a of the solid-state battery electrode layer 115 on the opposite electrode side that is separately opposed to the end face 141 (see FIG. 5).

FIG. 5 is a sectional view schematically illustrating the configuration of a packaged solid-state battery according to another aspect of the present invention. As found by the inventor of the present application, the stress acting on the substrate 200 side has a property that the stress gradually increases toward the interface region 180 side between the electrode layer 115 and the end-face electrode 140. Based on this point, it is preferable that the width dimension of the substrate electrode layer 210 is secured as compared with the case of the basic aspect illustrated in FIG. 2 in order to be able to receive the relatively large stress along the interface region 180 and the region close thereto. Specifically, the width dimension of the substrate electrode layer 210 is preferably equal to or more than the maximum distance L3. As a result, as compared with the basic aspect shown in FIG. 2, it is possible to expand the region of the substrate electrode layer 210 that can function as a planar stress-receiving layer.

As an example, the distance Li (corresponding to a width dimension) between the one side surface 211 and the another side surface 212 of the substrate electrode layer 210 is preferably 2.0 times or more of the minimum distance L2 in a sectional view (see FIG. 6).

FIG. 6 is a sectional view schematically illustrating the configuration of a packaged solid-state battery according to another aspect of the present invention. As described above, the stress that can act on the substrate 200 side has a property that the stress can gradually decrease from the interface region 180 toward the central region of the battery element 100X. Therefore, the stress along the region larger than 20% of and equal to or smaller than 50% of the width of the region between the interface region 180 and the central region 100X1 of the battery element 100X with respect to the interface region 180 is merely relatively slightly smaller than the stress along the region close to the interface region 180. Therefore, stress along this range also adversely affects the substrate 200 side.

Based on this point, the width dimension of the substrate electrode layer 210 is set to 2.0 times or more of the above-described minimum distance L2. As a result, as compared with the aspect shown in FIG. 4, it is possible to further expand the region of the substrate electrode layer 210 that can function as a planar stress-receiving layer. As a result, the stress along the region equal to or smaller than 50% of the width of the region between the interface region 180 and the central region 100X1 of the battery element 100X can also be suitably received by the “Surface” substrate electrode layer 210 having relatively high strength.

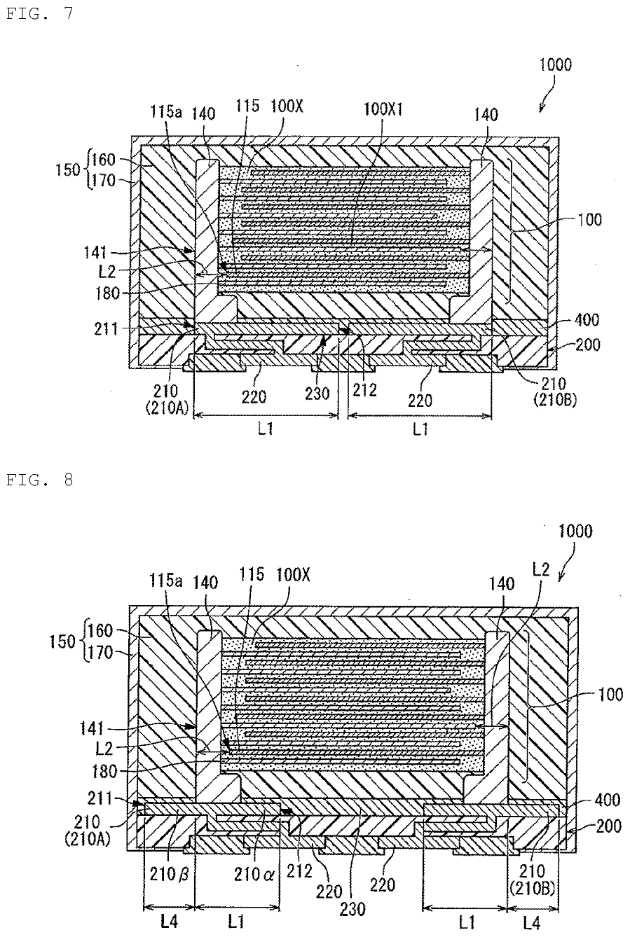

As an example, it is more preferable that the substrate electrode layer 210 extends along the main surface 230 of the substrate 200 on the side opposed to the solid-state battery 100 to such an extent that it does not come into contact with the substrate electrode layer 210 on the counter electrode side (see FIG. 7).

FIG. 7 is a sectional view schematically illustrating the configuration of a packaged solid-state battery according to another aspect of the present invention. As found by the inventor of the present application, the stress acting on the substrate 200 side has a property that the stress gradually increases from the central region 100X1 of the battery element 100X toward the interface region 180 side between the electrode layer 115 and the end-face electrode 140. In this regard, although there is a difference in the magnitude of the stress, the stress can act from the solid-state battery 100 side to the substrate 200 side along the whole region from the interface region 180 to the central region 100X1 side of the battery element 100X. For this reason, as illustrated in FIG. 7, it is more preferable that the substrate electrode layer 210 extends along the main surface 230 of the substrate 200 to such an extent that it does not come into contact with the substrate electrode layer 210 on the counter electrode side.

As a result, the substrate electrode layer 210 can receive the stress that can act on the substrate 200 side along the whole region from the interface region 180 to the central region 100X1 side of the battery element 100X.

In particular, when both the positive-electrode-side substrate electrode layer 210A and the negative-electrode-side substrate electrode layer 210B adopt the above configuration, the total width of both the substrate electrode layers 210A and 210B can be made close to the total width of the solid-state battery 100 in a sectional view. Therefore, both the substrate electrode layers 210A and 210B can receive almost all stress that can act on the substrate 200. As a result, cleavage of the substrate 200 can be more suitably suppressed.

In a preferred aspect, the one side surface 211 of the substrate electrode layer 210 is positioned more outward from the end face 141 of the end-face electrode 140 and positioned more inward from an end 231 of the main surface 230 of the substrate 200 in a sectional view (see FIG. 8).

FIG. 8 is a sectional view schematically illustrating the configuration of a packaged solid-state battery according to another aspect of the present invention. According to the configuration of the present aspect, the substrate electrode layer 210 can be located not only inside but also outside with respect to the end face 141 of the end-face electrode 140. Specifically, the substrate electrode layer 210 can extend outward from the end face 141 of the end-face electrode 140 along the main surface 230 of substrate 200 by the distance L4 between its one side surface 211 and the end face 141 of the end-face electrode 140.

In this case, the inner portion 210a of the substrate electrode layer 210 positioned on the inner side with respect to the end face 141 of the end-face electrode 140 functions as a planar stress-receiving layer as described above. On the other hand, since the substrate electrode layer 210 itself is a metal layer, the outer portion 210 (of the substrate electrode layer 210 positioned on the outer side with respect to the end face 141 of the end-face electrode 140 may be a portion that is relatively difficult for water vapor to transmit. This makes it possible to prevent water vapor infiltrating the solid-state battery 100 side from the external environment via the substrate 200.

As described above, the covering inorganic layer 170 also covers the side surface 250 of the substrate 200, and can be, for example, a metal film. Therefore, from the viewpoint of ensuring the electrical insulation between the substrate electrode layer 210 and the covering inorganic layer 170 without being in contact with each other, it is preferable that the one side surface 211 of the substrate electrode layer 210 is positioned more inward from the side surface of the substrate 200, that is, positioned more inward from the end 231 of the main surface 230 of the substrate 200.

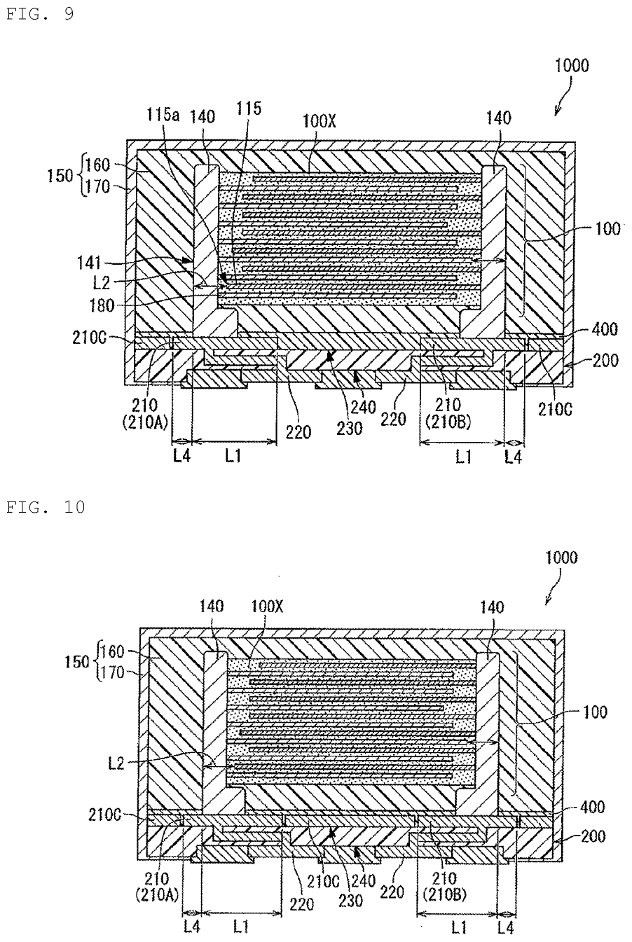

In a preferred aspect, the substrate 200 further has, on the main surface 230 of the substrate 200 on the side opposite to the solid-state battery 100, a dummy substrate electrode layer 210C that is disposed to be separately opposed to the substrate electrode layer 210 and is not electrically connected to the solid-state battery 100 (see FIG. 9).

FIG. 9 is a sectional view schematically illustrating the configuration of a packaged solid-state battery according to another aspect of the present invention. According to the configuration of the present aspect, the one main surface 230 of the substrate 200 has thereon at least: the substrate electrode layer 210 that can function as a planar stress-receiving layer; and the dummy substrate electrode layer 210C disposed separately therefrom. On the other hand, at least the substrate electrode layers 220 on the mounting side are provided on the another main surface 240 of the substrate 200 at a predetermined interval. In this regard, the presence of the dummy substrate electrode layer 210C has the following advantages as compared with the case where no one is present. Specifically, the arrangement patterns of the electrode layers arranged on the two opposing main surfaces 230 and 240 of the substrate 200 can be made similar. Therefore, warpage of the substrate 200 can be suppressed, and as a result, rigidity of the substrate 200 itself can be enhanced. In addition, the dummy substrate electrode layer 210C itself is a metal layer and may be a portion that is relatively difficult for water vapor to transmit. This makes it possible to prevent water vapor infiltrating the solid-state battery 100 side from the external environment via the substrate 200.

As illustrated in FIG. 10, the dummy substrate electrode layer 210C can be further disposed between the positive-electrode-side substrate electrode layer 210A and the negative-electrode-side substrate electrode layer 210B at an interval not to be in contact with both layers. According to such an arrangement, it is possible to further improve the rigidity and the water vapor barrier property of the substrate 200 itself. Furthermore, the dummy substrate electrode layer 210C in this case is located inside with respect to the end face 141 of the end-face electrode 140, and therefore can also function as a planar stress-receiving layer.

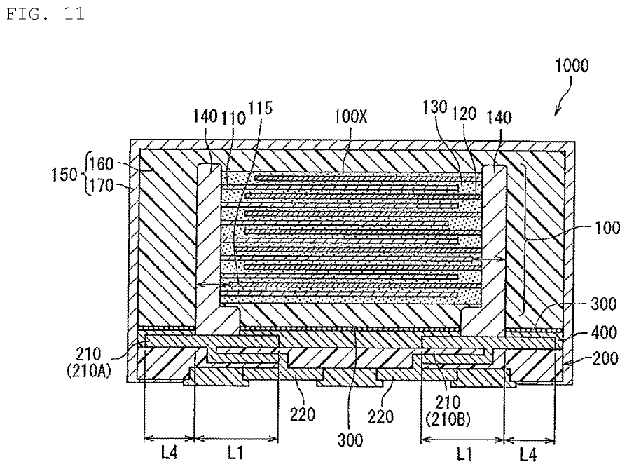

In a preferred aspect, a water vapor barrier layer 300 is preferably provided between the substrate 200 and the solid-state battery 100 (see FIG. 11).

FIG. 11 is a sectional view schematically illustrating the configuration of a packaged solid-state battery according to another aspect of the present invention. As described above, the solid-state battery package 1000 includes the substrate 200 and the solid-state battery 100 provided on the substrate 200. The substrate 200 is provided so as to block the main surface of solid-state battery 100 from the external environment. Therefore, it is usually considered that water vapor infiltration into the solid-state battery can be prevented by the presence of the substrate. In this regard, the substrate 200 alone may not sufficiently prevent water vapor transmission. This is because the substrate 200 can have permeability to water vapor in the external environment due to the material and/or configuration of the substrate 200.

For this reason, it is preferable to provide a water vapor barrier layer 300 between the solid-state battery 100 and the substrate 200. The water vapor barrier layer may have, for example, a film form. By disposing the water vapor barrier layer 300, it is possible to effectively suppress water vapor transmission to the solid-state battery 100 side through the substrate 200. This makes it possible to suppress a decrease in ionic conductivity of the solid electrolyte 130 due to, for example, a reaction between water vapor (moisture) infiltrating from the substrate 200 and the solid electrolyte 130.

The water vapor barrier layer 300 may be provided so as to be in contact with the covering insulating layer 160. That is, the covering insulating layer 160 is preferably provided so as to cover not only the side surface of the solid-state battery 100 but also the lower surface of the solid-state battery, and the water vapor barrier layer 300 may be provided so as to be in contact with such a covering insulating layer 160. This means that the water vapor barrier layer is provided between the sealing resin surrounding the periphery of the solid-state battery and the substrate. When the resist layer 400 is provided on the substrate 200, the water vapor barrier layer 300 may be disposed between the covering insulating layer 160 and the resist layer 400.

The thickness of each layer of the water vapor barrier layer, the solid-state battery, and the substrate may be based on an electron microscopic image. For example, the thickness of the water vapor barrier layer and the thickness of the layers constituting the substrate and the solid-state battery may be based on an image obtained by cutting out the cross section with an ion milling apparatus (model number IM 4000 PLUS; manufactured by Hitachi High-Tech Corporation) and using a scanning electron microscope (SEM) (model number SU-8040; manufactured by Hitachi High-Tech Corporation). That is, the thickness dimension in the present specification may refer to a value calculated from a dimension measured from an image acquired by such a method.

The term “barrier” as used herein means having such a property of blocking water vapor transmission that water vapor in the external environment does not pass through the substrate to cause undesirable characteristic deterioration for the solid-state battery, and in a narrow sense, means that the water vapor transmission rate is less than 5×10⁻³ g/(m²·Day). In short, the water vapor barrier layer preferably has a water vapor transmission rate of 0 g/(m²·Day) or more and less than 5×10⁻³ g/(m²·Day) (for example, 0.5×10⁻³ g/(m²·Day) or more and less than 5×10⁻³ g/(m²·Day)). Note that the term “water vapor transmission rate” mentioned herein refers to a transmission rate obtained by the MA method under measurement conditions of 85° C. and 85% RH using a gas transmission rate measuring device of model WG-15S manufactured by MORESCO Corporation.

In a preferred aspect, the water vapor barrier layer 300 is disposed so as to extend along the extending direction of the main surface 230 of the substrate 200 (see FIG. 11).

According to the arrangement of the water vapor barrier layer 300, as shown in FIG. 11, the water vapor barrier layer 300 may extend in the width direction of the solid-state battery package 1000, and may extend across the solid-state battery package 1000. This means that the water vapor barrier layer 300 extends in a direction orthogonal to the stacking direction of the solid-state battery. The water vapor barrier layer 300 extending widely in the direction of the main surface 230 of the substrate 300 as described above can more suitably prevent water vapor infiltrating from the external environment via the substrate 200. That is, the water vapor barrier layer 300 can more suitably act so that water vapor from the outside of the package does not finally reach the solid-state battery 100, and as a result, a suitable solid-state battery package 1000 in which deterioration of solid-state battery characteristics is suppressed in the long term is provided.

The water vapor barrier layer 300 extending in the direction along the main surface direction of the substrate 200 as described above is preferably provided widely to the region outside the solid-state battery 100. That is, it is preferable that the water vapor barrier layer 300 is provided over a wide range so as to protrude from the solid-state battery 100. For example, the water vapor barrier layer 300 may extend to the covering material that covers the solid-state battery 100.

For example, the water vapor barrier layer 300 may extend to the outer surface of the covering insulating layer 160 that covers the solid-state battery 100 on the substrate 200. That is, when the solid-state battery package 1000 has the covering insulating layer 160 provided on the substrate 200 so as to cover at least the main surface 100A and the side surface 100B of the solid-state battery 100, the water vapor barrier layer 300 preferably extends to the outer surface 160A of the covering insulating layer 160 that covers the side surface 100B of the solid-state battery (see FIG. 11). This makes it possible to more suitably prevent water vapor infiltrating from the external environment via the substrate 200. That is, the water vapor barrier layer 300 can more reliably act so that the external water vapor infiltrating through the substrate 200 does not reach the solid-state battery 100.

In a preferred aspect, the water vapor barrier layer 300 is an insulating layer having electrical insulation properties. That is, the water vapor barrier layer 300 may be a film including a material having a high electrical insulation property. This is because a disadvantageous phenomenon such as short circuit can be more easily suppressed. That is, it is possible to prevent the water vapor transmission and also suppress an electrically disadvantageous influence thereof and the like. Such a water vapor barrier layer 300 is not particularly limited as long as it is a material exhibiting insulating properties. Specific examples of the material include inorganic insulators such as glass and alumina, organic insulators such as resins, and the like. These may be used alone, or may be used in combination of two or more thereof.

As an example, as illustrated in FIG. 11, the water vapor barrier layer 300 may have a single-layer form. Alternatively, the water vapor barrier layer 300 may have a form including a plurality of layers (that is, a multilayer form described below). There is no particular limitation on them as long as desired water vapor transmission prevention properties are provided.

In a preferred embodiment, the water vapor barrier layer 300 is an insulating multilayer film. The water vapor barrier property of the water vapor barrier layer 300 can be improved by multilayering. In such an insulating multilayer film, the same film may be formed a plurality of times, or different films may be formed. In the case of different films, an organic insulating barrier layer may be formed on the inorganic insulating barrier layer.

In a preferred aspect, the water vapor barrier layer 300 is provided so as to substantially largely occupy the plan view area of the solid-state battery package 1000. Specifically, the water vapor barrier layer 300 may be provided large so as to occupy the whole region except for the connection region between the end-face electrode 140 and the substrate electrode layer 210 of the solid-state battery 100. As described above, the water vapor barrier layer 300 having a large area in plan view can more reliably prevent water vapor infiltrating from the external environment through the substrate 200.

The water vapor barrier layer is preferably a layer containing silicon. This is because the layer tends to be suitable in terms of electrical insulation. The water vapor barrier layer containing silicon may be a layer composed of a molecular structure containing not only silicon atoms but also nitrogen atoms and oxygen atoms. This is because the layer tends to be suitable in terms of electrical insulation and thinning. For example, the water vapor barrier layer has both an Si—O bond and an Si—N bond. That is, both the Si—O bond and the Si—N bond may be present in the molecular structure constituting the material of the water vapor barrier layer. When the molecular structure of the layer has both an Si—O bond and an Si—N bond, the layer tends to be a thin layer but a dense layer, and tends to be a water vapor barrier layer that can exhibit more water vapor transmission prevention characteristics.

The water vapor barrier layer containing silicon and the water vapor barrier layer having both an Si—O bond and an Si—N bond are not based on siloxane. That is, the water vapor barrier layer according to the present invention has a molecular structure containing silicon and an Si—O bond but not containing a siloxane skeleton.

As used herein, the term “Si—O bond” and “Si—N bond” refer to those that can be confirmed, for example, based on Fourier transform infrared spectroscopy (FT-IR). That is, in the water vapor barrier layer according to such an aspect, the Si—O bond and the Si—N bond can be confirmed by measuring the absorption of light in the infrared region. In the present specification, FT-IR refers to, for example, those measured by the microscopic ATR method using Spotlight 150, which is manufactured by PerkinElmer Inc.

In addition, the water vapor barrier layer having an Si—O bond and an Si—N bond can be a layer having relatively high toughness. This means that the water vapor barrier layer suitably acts during charging and discharging of the solid-state battery. When the solid-state battery is charged and discharged, ions move between the positive and negative electrode layers through the solid electrolyte layer, and thereby the solid-state battery may expand and contract. However, when subjected to such a stress of expansion and contraction, the water vapor barrier layer, having high toughness, is less likely to being cleaved or cracked. Usually, a layer having a high water vapor barrier property may be densely hard and have a tendency to be easily cleaved or cracked due to stress or the like, whereas a layer having a relatively soft property without being cleaved or cracked may have a tendency to have a low water vapor barrier property. In this respect, the water vapor barrier layer containing an Si—O bond and an Si—N bond becomes a layer that is less likely to be cleaved or cracked when subjected to stress of expansion and contraction by the solid-state battery, but is excellent in water vapor permeability, increasing in reliability as a solid-state battery package.

Preferably, the water vapor barrier layer having Si—O bonds and Si—N bonds is formed from a liquid raw material. Specifically, it is preferable to form a water vapor barrier layer having both an Si—O bond and an Si—N bond by applying a liquid raw material to a substrate and subjecting the substrate to light irradiation. As a result, the water vapor barrier layer can be formed without being subjected to a higher temperature, and the adverse thermal influence on the substrate can be suppressed. In addition, the vacuum vapor deposition method and the like require an expensive vapor deposition apparatus, but formation using such a liquid raw material does not require such an expensive apparatus, and also relatively suppress the cost. Furthermore, although a layer formed by a vacuum vapor deposition method or the like may cause warpage of the substrate due to stress acting on the layer, the layer formed from a liquid raw material as described above has little or substantially no such stress. Therefore, when the water vapor barrier layer is produced from the liquid raw material, the possibility that the substrate warps or the like is reduced or prevented.

In addition, in an aspect of the present invention, a resist layer 400 can be disposed between the substrate 200 and the solid-state battery 100 (see FIG. 2 and the like). In particular, due to the resist provided on the substrate 200, the resist layer 400 may be provided between the substrate 200 and the solid-state battery 100.

The resist layer 400 is particularly provided on the main surface of the substrate 200. The resist layer 400 is a layer that at least partly covers the substrate surface in order to keep away physical processing or chemical reaction. Therefore, the resist layer may be an insulating layer including a resin material provided on the main surface of the substrate 200. Such a resist layer can also be regarded as corresponding to a heat-resistant coating provided on the main surface of the substrate 200. For example, the resist may be used to maintain insulation at the time of connection between the solid-state battery and the substrate and to protect a conductor portion such as the substrate electrode layers. The resist layer 400 provided on the main surface of the substrate 200 may be, for example, a solder resist layer.

As an example, the resist layer 400 may be provided on the main surface of the substrate 200. In such a case, the water vapor barrier layer 300 may be disposed at least on the resist layer 400. The water vapor barrier layer 300 is disposed so as to be in direct contact with the resist layer 400 such that the water vapor barrier layer 300 and the resist layer 400 are stacked on each other. When the water vapor barrier layer is provided on the resist layer as described above, water vapor infiltrating from the external environment via the substrate 200 and the resist layer 400 thereon can be more effectively prevented.

[Method for Manufacturing Solid-State Battery Package]

The objective product according to the present invention can be obtained through a process of preparing a solid-state battery that includes a battery constituent unit including a positive electrode layer, a negative electrode layer, and a solid electrolyte between the electrodes and next packaging the solid-state battery.

The manufacture of the solid-state battery according to the present invention can be roughly divided into: manufacturing a solid-state battery itself (hereinafter, also referred to as an “unpackaged battery”) corresponding to a stage prior to packaging; preparing a substrate; and packaging.

<<Method for Manufacturing Unpackaged Battery>>

The unpackaged battery can be manufactured by a printing method such as screen printing, a green sheet method with a green sheet used, or a combined method thereof. More particularly, the unpackaged battery itself may be fabricated in accordance with a conventional method for manufacturing a solid-state battery (thus, for raw materials such as the solid electrolyte, organic binder, solvent, optional additives, positive electrode active material, and negative electrode active material described below, those for use in the manufacture of known solid-state batteries may be used).

Hereinafter, for better understanding of the present invention, one manufacturing method will be exemplified and described, but the present invention is not limited to this method. In addition, the following time-dependent matters such as the order of descriptions are merely considered for convenience of explanation and are not necessarily bound by the matters.

(Formation of Stack Block)

The solid electrolyte, the organic binder, the solvent, and optional additives are mixed to prepare a slurry. Then, from the prepared slurry, sheets including the solid electrolyte are formed by firing.

The positive electrode active material, the solid electrolyte, the conductive material, the organic binder, the solvent, and optional additives are mixed to prepare a positive electrode paste. Similarly, the negative electrode active material, the solid electrolyte, the conductive material, the organic binder, the solvent, and optional additives are mixed to prepare a negative electrode paste.

The positive electrode paste is applied by printing onto the sheet, and a current collecting layer and/or a negative layer are applied by printing, if necessary. Similarly, the negative electrode paste is applied by printing onto the sheet, and a current collecting layer and/or a negative layer are applied by printing, if necessary.

The sheet with the positive electrode paste applied by printing and the sheet with the negative electrode paste applied by printing are alternately stacked to obtain a stacked body. Further, the outermost layer (the uppermost layer and/or the lowermost layer) of the stacked body may be an electrolyte layer, an insulating layer, or an electrode layer.

(Formation of Battery Fired Body)

The stacked body is integrated by pressure bonding, and then cut into a predetermined size. The cut stacked body obtained is subjected to degreasing and firing. Thus, a fired stacked body is obtained. The stacked body may be subjected to degreasing and firing before cutting, and then cut.

(Formation of End-face Electrode)

The end-face electrode on the positive electrode side can be formed by applying a conductive paste to the positive electrode-exposed side surface of the fired stacked body. Similarly, the end-face electrode on the negative electrode side can be formed by applying a conductive paste to the negative electrode-exposed side surface of the fired stacked body. The end-face electrodes on the positive electrode side and the negative electrode side may be provided so as to extend to a main surface of the fired laminate. The component for the end-face electrode can be selected from at least one selected from silver, gold, platinum, aluminum, copper, tin, and nickel.

Further, the end-face electrodes on the positive electrode side and the negative electrode side are not limited to being formed after firing the stacked body, and may be formed before the firing and subjected to simultaneous firing.

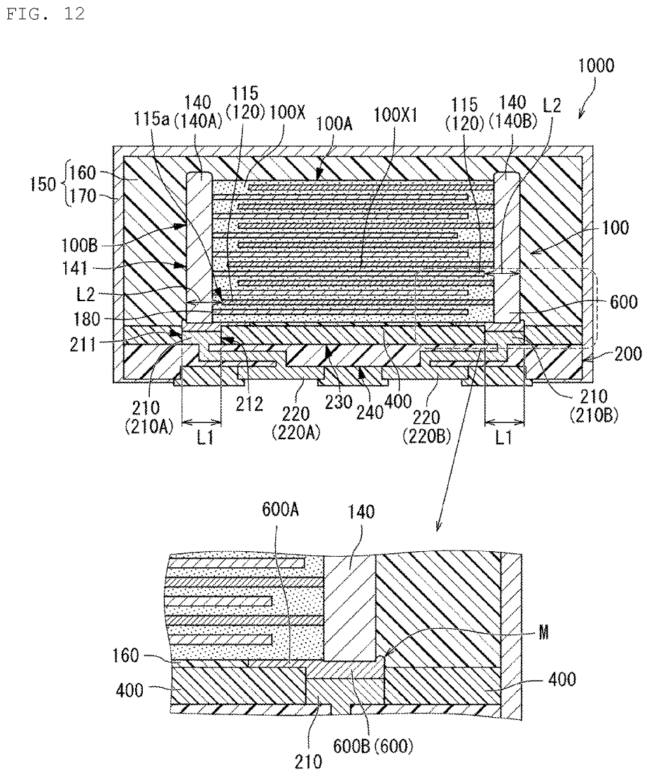

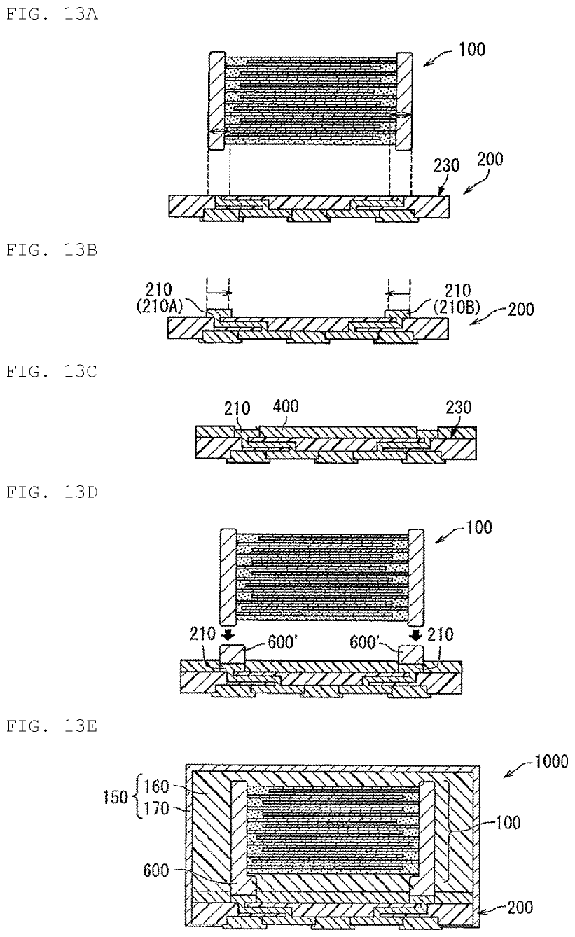

Through the steps described above, a desired unpackaged battery (corresponding to the solid-state battery 100 illustrated in FIG. 13A) can be finally obtained.

<<Preparation of Substrate>>

In this step, the substrate is prepared.

Although not particularly limited, in the case of using a resin substrate as the substrate, the substrate may be prepared by stacking multiple layers and then performing heating and pressurizing treatments for the layers. For example, a substrate precursor is formed using a resin sheet made by impregnating a fiber cloth as a substrate with a resin raw material. After the formation of the substrate precursor, the substrate precursor is subjected to heating and pressurization with a press machine. In contrast, in the case of using a ceramic substrate as the substrate, for the preparation thereof, for example, multiple green sheets can be subjected to thermal compression bonding to form a green sheet laminate, and the green sheet laminate can be subjected to firing, thereby providing a ceramic substrate. The ceramic substrate can be prepared, for example, in accordance with the preparation of an LTCC substrate. The ceramic substrate may have vias and/or lands. In such a case, for example, holes may be formed for the green sheet with a punch press, a carbon dioxide gas laser, or the like, and filled with a conductive paste material, or a conductive part precursor such as vias and lands may be formed through performing a printing method or the like. Further, lands and the like can also be formed after firing the green sheet laminate.

Thereafter, the substrate electrode layer 210 is formed on the main surface 230 of the substrate 200 for electrical connection (see FIG. 13B). The substrate electrode layer may be appropriately patterned. Specifically, the substrate electrode layer 210 is formed on the surface of the substrate, so that, with respect to a case where one side surface of the substrate electrode layer and an end face of the end-face electrode on the same electrode side of the subsequently disposed solid-state battery are substantially on an identical line in a sectional view, the distance between one side surface and another side surface of the substrate electrode layer is equal to or more than a minimum distance between the end face of the end-face electrode on the same electrode side and a side surface of the solid-state battery electrode layer on an opposite electrode side that is separately opposed to the end face.

After the substrate electrode layer 210 is formed, a resist layer 400 made of, for example, solder resist may be formed on the main surface 230 of the substrate 200 excluding the substrate electrode layer (see FIG. 13C). The step of forming the resist layer 400 may be omitted. By carrying out the steps as described above, a desired substrate can be finally obtained.

<<Packaging>>

Next, packaging is performed using the battery and substrate obtained as mentioned above.

First, the unpackaged battery 100 is placed on the substrate 200 (see FIG. 13D). More particularly, the “unpackaged solid-state battery” is placed on the substrate (hereinafter, the battery used for packaging is also simply referred to as a “solid-state battery”).

Specifically, the solid-state battery is disposed on the substrate such that the substrate electrode layer and the end-face electrode of the solid-state battery are electrically connected to each other. For example, the solid-state battery is disposed while the end face of the end-face electrode of the solid-state battery placed on the substrate and one side surface of the substrate electrode layer are adjusted to be substantially on an identical line. Note that the end face of the end-face electrode of the solid-state battery and one side surface of the substrate electrode layer do not necessarily have to be substantially an identical line, and the one side surface of the substrate electrode layer may be disposed more outward from the end face of the end-face electrode of the solid-state battery in a sectional view. At this time, for example, a conductive paste (for example, Ag conductive paste) may be provided on the substrate electrode layer of the substrate before the solid-state battery is disposed, thereby electrically connecting the conductive portion of the support substrate and the end-face electrode of the solid-state battery to each other. More particularly, a precursor 600′ of the bonding member that plays a part in electrical connection between the solid-state battery 100 and the substrate 200 may be provided in advance. Such a precursor 600′ of the bonding member can be provided by printing with a conductive paste that requires no cleaning such as flux after being formed, such as a nano-paste, an alloy-based paste, and a brazing material, in addition to an Ag conductive paste. The solid-state battery 100 is disposed on the substrate so that the end-face electrode of the solid-state battery and the precursor 600′ of the bonding member are in contact with each other, and then subjected to a heat treatment, whereby the bonding member 600 contributing to electrical connection between the solid-state battery 100 and the substrate 200 is formed from the precursor 600′.

Next, the covering material 150 is formed. As the covering material, a covering insulating layer 160 and a covering inorganic layer 170 may be provided (see FIG. 13E).

First, the covering insulating layer 160 is formed so as to cover the solid-state battery 100 on the substrate 200. Hence, a raw material for the covering insulating layer is provided such that the solid-state battery on the substrate is totally covered. When the covering insulating layer is made of a resin material, a resin precursor is provided on the substrate and subjected to curing or the like to mold the covering insulating layer. According to a preferred aspect, the covering insulating layer may be molded by pressurization with a mold. By way of example only, a covering insulating layer for sealing the solid-state battery on the substrate may be molded through compression molding. In a case of a resin material generally for use in molding, the form of the raw material for the covering insulating layer may be granular, and the type thereof may be thermoplastic. It is to be noted that such molding is not limited to die molding, and may be performed through polishing processing, laser processing, and/or chemical treatment.

After the covering insulating layer 160 is formed, the covering inorganic layer 170 is formed. Specifically, the covering inorganic layer 170 is formed on the “covering precursor in which each solid-state battery 100 is covered with the covering insulation layer 160 on the substrate 200”. For example, dry plating may be performed to form a dry plating film as the covering inorganic layer. More specifically, dry plating is performed to form the covering inorganic layer on the exposed surface other than the bottom surface of the covering precursor (that is, other than the bottom surface of the support substrate).

Through the steps described above, it is possible to obtain a packaged article in which the solid-state battery on the substrate is totally covered with the covering insulating layer and the covering inorganic layer. More particularly, the “solid-state battery package” according to the present invention can be finally obtained.

In the above description, an aspect in which the covering material 150 covers the solid-state battery 100 has been mentioned, but the present invention may have an aspect in which the solid-state battery 100 is largely covered with the covering material 150. For example, the covering inorganic layer 170 provided on the covering insulating layer 160 that covers the solid-state battery 100 on the substrate 200 may extend to the lower main surface of the substrate 200 (see FIG. 2). That is, as the covering material 150, the covering inorganic layer 170 on the covering insulating layer 160 may extend to the side surface of the substrate 200, and beyond the side of the substrate 200, extend to the lower main surface (particularly, the peripheral edge portion thereof) of the substrate 200. In the case of such a form, a solid-state battery package may be provided in which moisture transmission (moisture transmission from the outside to the solid-state battery stacked body) is more suitably prevented. As illustrated in FIG. 11, the covering inorganic layer 170 can also be provided as a multilayer structure composed of at least two layers. In FIG. 11, the covering inorganic layer 170 having a two-layer structure of 170A and 170B is illustrated. Such a multilayer structure is not particularly limited to between different types of materials, and may be between the same type of materials. When the covering inorganic layer having such a multilayer structure is provided, it is easy to more suitably configure the water vapor barrier for the solid-state battery.

Preferably, the substrate may have a water vapor barrier layer having been formed thereon. More particularly, the water vapor barrier may be formed for the substrate, prior to the packaging, where the substrate and the solid-state battery are combined.

The water vapor barrier layer is not particularly limited as long as a desired barrier layer can be formed. For example, in the case of the “water vapor barrier layer having an Si—O bond and an Si—N bond”, the water vapor barrier layer is preferably formed through application of a liquid raw material and ultraviolet irradiation. More particularly, the water vapor barrier layer is formed under a relatively low temperature condition (for example, a temperature condition on the order of 100° C.) without using any vapor-phase deposition method such as CVD or PVD.

Specifically, a raw material containing, for example, silazane is prepared as the liquid raw material, and the liquid raw material is applied to the substrate by spin coating, spray coating, or the like, and dried to form a barrier precursor. Then, the barrier precursor can be subjected to UV irradiation in an environmental atmosphere containing nitrogen, thereby providing the “water vapor barrier layer having an Si—O bond and an Si—N bond”.

In order that the water vapor barrier layer is not present at the bonding site of the conductive portion of the substrate and the end-face electrode of the solid-state battery, it is preferable to locally remove the barrier layer at the site. Alternatively, a mask may be used such that the water vapor barrier layer is not formed at the bonding site. More particularly, the water vapor barrier layer may be totally formed with a mask applied to the region for the bonding site, and then the mask may be removed.

When a resist layer is provided on the main surface of the substrate, a water vapor barrier layer may be formed on the resist layer 400. At this time, as described above, it is preferable to form the water vapor barrier layer so as to exclude the bonding region with the solid-state battery 100. That is, it is preferable to prepare the substrate 200 on which the resist layer 400 and the water vapor barrier layer 300 are formed so that the substrate electrode layer 210 of the substrate is exposed.

Although the aspects of the present invention have been described above, only typical examples have been illustrated. Those skilled in the art will easily understand that the present invention is not limited thereto, and various aspects are conceivable without changing the gist of the present invention.

For example, in the above description, an aspect in which the conductive portion of the substrate and the end-face electrode of the solid-state battery are electrically connected to each other using a conductive paste has been mentioned, and the conductive paste corresponding to the provided bonding member 600 may finally have a form as shown in FIG. 12. When the solid-state battery 100 and the substrate 200 are electrically connected via the conductive paste, a pressing force is applied from the solid-state battery 100 to the conductive paste, so that the end-face electrode 140 of the solid-state battery 100 tends to slightly bite into the conductive paste. That is, the conductive paste is likely to have a form in which it is pressed by the end-face electrode 140 and slightly swells outside thereof (the “M” portion in FIG. 12). When the solid-state battery 100 and the substrate 200 are electrically bonded to each other with the conductive paste interposed therebetween, a part 600A of the conductive paste may flow so as to straddle the resist layer 400 due to the pressing. This is related to the fact that the resist layer 400 acts as a “dam” on the conductive paste.

More specifically, in the opening portion of the resist layer 400 where the conductive portion of the substrate (in particular, the main surface electrode layer 210 of the substrate) is exposed, the edge portion forming the opening acts so as to partly prevent the conductive paste moving. Therefore, while the part 600A of the conductive paste once provided into the opening portion flows onto the resist layer 400 along with the pressing, a large part 600B of the conductive paste can remain in the opening portion of the resist layer 400. That is, preferably, the resist layer (for example, a solder resist layer) acts as a dam to suppress the bleeding of the conductive paste. When the bleeding of the conductive paste is suppressed, the bonding area between the covering insulating layer 160 (particularly, the covering insulating layer 160 provided between the solid-state battery 100 and the substrate 200) and the resist layer 400 is more easily secured. As a result, the fixing force between the covering insulating layer 160 and the substrate 200 can be further stabilized. Although the conductive paste is expressed on the premise of manufacturing, the conductive paste corresponds to the bonding member 600 in the manufactured solid-state battery. Therefore, in the solid-state battery package 1000 according to an aspect of the present disclosure, as illustrated in FIG. 12, the bonding member 600 can be disposed so as to straddle the upper main surface electrode layer 210 of the substrate and the resist layer 400. That is, the part 600A of the bonding member 600 can be disposed inward from the resist layer 400. Specifically, the part 600A of the bonding member 600 can be disposed more inward from the portion of the resist layer 400 in contact with the upper main surface electrode layer 210.

Although the present invention relates to a solid-state battery package, the package may be provided as an electronic device mounted on an external board separate from the substrate. That is, while the substrate of the solid-state battery package can be a terminal substrate for the external terminal of the solid-state battery, the solid-state battery package may be surface-mounted on an external board (that is, the secondary substrate) such as a printed wiring board via the terminal substrate, and the solid-state battery package may be provided as such an electronic device.

The solid-state battery package according to the present invention can be used in various fields where battery use or power storage can be assumed. By way of example only, the solid-state battery package according to the present invention can be used in the fields of electricity, information, and communication in which mobile devices and the like are used (such as the field of electric/electronic devices and the field of mobile devices including small electronic devices such as mobile phones, smartphones, notebook computers and digital cameras, activity trackers, arm computers, electronic paper, RFID tags, card-type electronic money, and smartwatches), home and small industrial applications (such as the fields of power tools, golf carts, and home, nursing, and industrial robots), large industrial applications (such as the fields of forklifts, elevators, and harbor cranes), the field of transportation systems (such as the fields of hybrid vehicles, electric vehicles, buses, trains, power-assisted bicycles, and electric two-wheeled vehicles), power system applications (such as the fields of various types of power generation, road conditioners, smart grids, and home energy storage systems), medical applications (field of medical equipment such as earphone hearing aids), pharmaceutical applications (fields such as dosage management systems), IoT fields, space and deep sea applications (such as the fields of space probes and submersibles), and the like.

### DESCRIPTION OF REFERENCE SYMBOLS

100: Solid-state battery
100A: Main surface of solid-state battery
100B: Side surface of solid-state battery
100X: Battery element
100X1: Central region of interface region and battery element
110: Positive electrode layer
115: Solid-state battery electrode layer
115a: Side surface of solid-state battery electrode layer
120: Negative electrode layer
130: Solid electrolyte or solid electrolyte layer
140: End-face electrode
140A: End-face electrode on positive electrode side
140B: End-face electrode on negative electrode side
141: End face of end-face electrode
150: Covering material
160: Covering insulating layer
170: Covering inorganic layer
180: Interface region of solid-state battery electrode layer and end-face electrode
200: Substrate
210: Substrate electrode layer (substrate upper side)
210A: Positive-electrode-side substrate electrode layer
210B: Negative-electrode-side substrate electrode layer
211: One side surface of substrate electrode layer
212: Another side surface of substrate electrode layer
220: Substrate electrode layer on mounting side (substrate lower side)
220A: Positive-electrode-side substrate electrode layer on mounting side
220B: Negative-electrode-side substrate electrode layer on mounting side
230: One main surface of substrate
240: Another main surface of substrate
250: Side surface of substrate
300: Water vapor barrier layer
400: Resist layer
600: Bonding member
600A: Part of bonding member
600B: Large part of bonding member
600′: Bonding member precursor
1000: Solid-state battery package
L1: Distance between one side surface and another side surface of substrate electrode layer
L2: Minimum distance between end face of end-face electrode on the same electrode side and side surface of solid-state battery electrode layer on opposite electrode side
L3: Maximum distance between end face of end-face electrode on the same electrode side and side surface of solid-state battery electrode layer on opposite electrode side
L4: Distance between one side surface of substrate electrode layer and end face of end-face electrode

1. A solid-state battery package comprising:
a substrate; and
a solid-state battery on the substrate,
wherein the solid-state battery has:
a battery element having a positive electrode layer, a negative electrode layer, and a solid electrolyte interposed between the positive electrode layer and the negative electrode layer; and
an end-face electrode on an end face of the battery element and connected to one of the positive electrode layer or the negative electrode layer,
wherein the substrate has, on a main surface thereof on a side opposite to the solid-state battery, a substrate electrode layer, and
at least a first side surface of the substrate electrode layer and a first end face of the end-face electrode are substantially on an identical line in a sectional view of the solid-state battery package, a distance between the first side surface and a second side surface of the substrate electrode layer opposite to the first side surface is equal to or more than a minimum distance between the first end face of the end-face electrode and an end surface of the one of the positive electrode layer or the negative electrode layer that the end-face electrode is not connected.

2. The solid-state battery package according to claim 1, wherein the second side surface of the substrate electrode layer and the end surface of the one of the positive electrode layer or the negative electrode layer that the end-face electrode is not connected are substantially on an identical line in the sectional view.

3. The solid-state battery package according to claim 1, wherein the second side surface of the substrate electrode layer is positioned more inward from an interface region of the one of the positive electrode layer or the negative electrode layer that the end-face electrode is not connected and the end-face electrode in the sectional view.

4. The solid-state battery package according to claim 1, wherein the substrate electrode layer is a metal layer.

5. The solid-state battery package according to claim 1, wherein the substrate electrode layer is a stress-receiving layer.

6. The solid-state battery package according to claim 1, wherein the second side surface of the substrate electrode layer is positioned more inward from the end surface of the one of the positive electrode layer or the negative electrode layer that the end-face electrode is not connected in the sectional view.

7. The solid-state battery package according to claim 1, wherein the substrate electrode layer extends to a position where the substrate electrode layer is opposed to the one of the positive electrode layer or the negative electrode layer that the end-face electrode is not connected in the sectional view.

8. The solid-state battery package according to claim 1, wherein a distance between the first side surface and the second side surface of the substrate electrode layer is 1.5 times or more of the minimum distance in the sectional view.

9. The solid-state battery package according to claim 1, wherein the distance between the first side surface and the second side surface of the substrate electrode layer is 2.0 times or more of the minimum distance in the sectional view.

10. The solid-state battery package according to claim 1, wherein the substrate further has, on the main surface of the substrate, a dummy substrate electrode layer that is separately opposed to the substrate electrode layer and is not electrically connected to the solid-state battery.

11. The solid-state battery package according to claim 1, further comprising a water vapor barrier layer between the substrate and the solid-state battery.

12. The solid-state battery package according to claim 11, wherein the water vapor barrier layer extends along an extending direction of the main surface of the substrate.

13. The solid-state battery package according to claim 11, further comprising a covering insulating layer covering a main surface and a side surface of the solid-state battery on the substrate,
wherein the water vapor barrier layer extends to an outer surface of the covering insulating layer which covers the side surface of the solid-state battery.

14. The solid-state battery package according to claim 11, wherein the water vapor barrier layer is an insulating layer having an electrical insulation property.

15. The solid-state battery package according to claim 11, wherein the water vapor barrier layer has both an Si—O bond and an Si—N bond.

16. The solid-state battery package according to claim 11, further comprising a resist layer between the substrate and the water vapor barrier layer.

17. The solid-state battery package according to claim 1, wherein the substrate is a resin substrate.

18. A solid-state battery package comprising:
a substrate; and
a solid-state battery on the substrate,
wherein the solid-state battery has:
a battery element having a positive electrode layer, a negative electrode layer, and a solid electrolyte interposed between the positive electrode layer and the negative electrode layer; and
an end-face electrode on an end face of the battery element and connected to one of the positive electrode layer or the negative electrode layer,
wherein the substrate has, on a main surface thereof on a side opposite to the solid-state battery, a substrate electrode layer, and
at least a first side surface of the substrate electrode layer is positioned more outward from an end face of the end-face electrode and positioned more inward from an end of the main surface of the substrate in a sectional view of the solid-state battery package, and a distance between the first side surface and a second side surface of the substrate electrode layer opposite to the first side surface is equal to or more than a minimum distance between the first end face of the end-face electrode and an end surface of the one of the positive electrode layer or the negative electrode layer that the end-face electrode is not connected.

19. The solid-state battery package according to claim 18, further comprising a water vapor barrier layer between the substrate and the solid-state battery.

20. The solid-state battery package according to claim 19, further comprising a resist layer between the substrate and the water vapor barrier layer.
